(19) United States
(12) Patent Application Publication
(10) Pub. No.: US 2017/0356297 A1
(43) Pub. Date: Dec. 14, 2017

(54) Lockwire Tab Backcut For Blade Stress Reduction (9E.04)

(71) Applicant: General Electric Company, Schenectady, NY (US)

(72) Inventors: Jason Adam Neville, Greenville, SC (US); William Scott Zemitis, Simpsonville, SC (US); Nicholas Alvin Hogberg, Greenville, SC (US); Mohankumar Banakar, Bangalore (IN)

(21) Appl. No.: 15/180,842

(22) Filed: Jun. 13, 2016

(51) Int. Cl. F01D 5/30; F01D 5/18

(52) U.S. Cl. CPC F01D 5/3007; F01D 5/187; F05D 2260/81; F05D 2230/10; F05D 2220/32

(57) ABSTRACT

The present application thus provides a method for reducing stress on a turbine blade wherein each of the turbine blades includes a dovetail with lockwire tab. The method may include the steps of (a) determining a starting line for a backcut relative to a lockwire tab end, (b) determining a cut angle for the backcut, and (c) removing material from the lockwire tab according to the starting line and the cut angle to form the dovetail backcut. The starting line may be positioned about 0.6 inches (about 15.24 millimeters), plus or minus 0.065 inches (about 1.65 millimeters) from the lockwire tab end along the dovetail axis.

### TECHNICAL FIELD

The present application and the resultant patent relate generally to gas turbine engines and more particularly relate to a modified turbine blade lockwire tab designed to divert the load path of a mounted turbine blade around a stress concentrating feature.

### BACKGROUND OF THE INVENTION

Gas turbine disks may include a number of circumferentially spaced dovetails about the outer periphery of the disk defining dovetail slots therebetween. Each of the dovetail slots may receive a turbine blade axially therein. The turbine blade may have an airfoil portion and a blade dovetail with a shape complementary to the dovetail slots. The turbine blade may be cooled by air entering through a cooling slot in the disk and through grooves or slots formed in the dovetail portions of the blade. Typically, the cooling slots may extend circumferentially therearound through the alternating dovetails and dovetail slots.

The interface locations between the blade dovetails and the dovetail slots are potentially life-limiting locations due to overhanging blade loads and stress concentrating geometries. In the past, dovetail backcuts have been used in certain turbine engines to relieve such stresses. These backcuts, however, were minor in nature were not optimized to balance stress reduction on the disk, stress reduction on the turbine blades, and a useful life of the turbine blades.

Similarly, the turbine blades may be prevented by moving axially in the dovetail slots by a lockwire passing through circumferentially aligned tabs positioned about the dovetail of the respective turbine blades. These lockwire tabs also may have stress concentrating geometries that may benefit from optimized cutbacks.

There is thus a desire for improved turbine blades and/or disks and the interaction therebetween. Such improved turbine blades and/or disks may promote overall stress reduction for an improved turbine blade lifetime and improved system efficiency without negatively impacting the aeromechanical behavior of the turbine blades.

### SUMMARY OF THE INVENTION

The present application and the resultant patent thus provide a method for reducing stress on a turbine blade wherein each of the turbine blades includes a dovetail with lockwire tab. The method may include the steps of (a) determining a starting line for a backcut relative to a lockwire tab end, (b) determining a cut angle for the backcut, and (c) removing material from the lockwire tab according to the starting line and the cut angle to form the dovetail backcut. The starting line may be positioned about 0.6 inches (about 15.24 millimeters), plus or minus 0.065 inches (about 1.65 millimeters) from the lockwire tab end along the dovetail axis.

The present application and the resultant patent further provide a turbine blade. The turbine blade may include an airfoil and a blade dovetail, wherein the blade dovetail a lockwire tab with includes a backcut sized and positioned according to optimized blade geometry. A starting line of the backcut, which defines a length of the backcut along a dovetail axis, is about 0.6 inches (about 15.24 millimeters), plus or minus 0.065 inches (about 1.65 millimeters) from a lockwire tab end along the dovetail axis.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, and a load.

FIG. 2 is a perspective view of a turbine disk segment with an attached turbine blade.

FIG. 3 is a perspective view of the suction side of the turbine blade of FIG. 2.

FIG. 4 is a perspective view of the pressure side of the turbine blade of FIG. 2.

FIG. 5 is a partial perspective view of a turbine blade with a lockwire tab as may be described herein.

FIG. 6 is a partial sectional view of the turbine blade lockwire tab of FIG. 5.

FIG. 7 is a partial perspective view of an alternative embodiment of a turbine blade with a lockwire tab as may be described herein.

### DETAILED DESCRIPTION

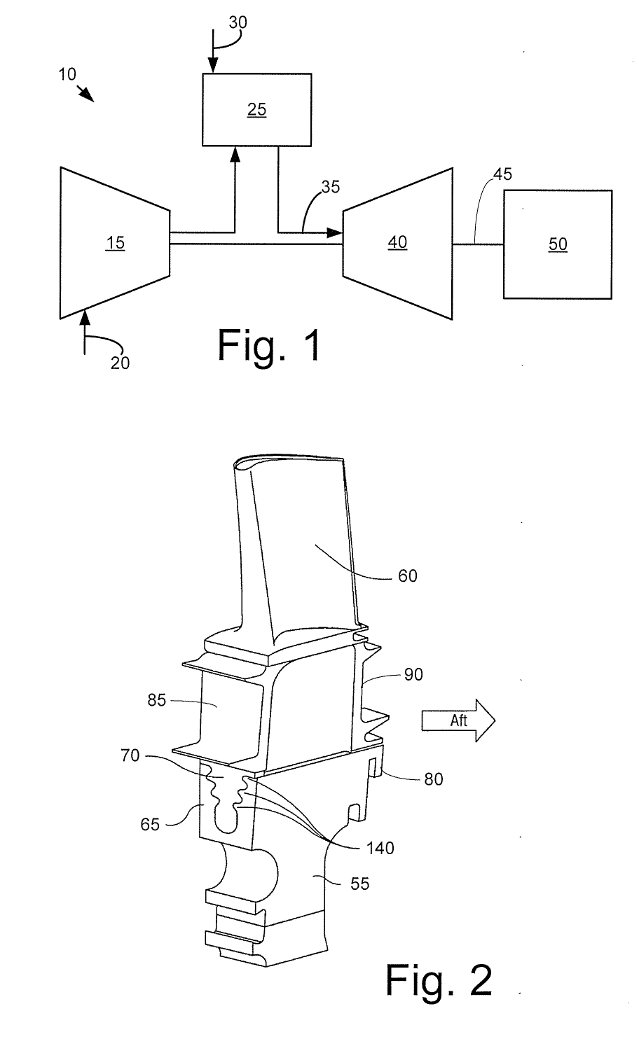

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25 positioned in a circumferential array and the like. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, liquid fuels, and/or other types of fuels and blends thereof. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

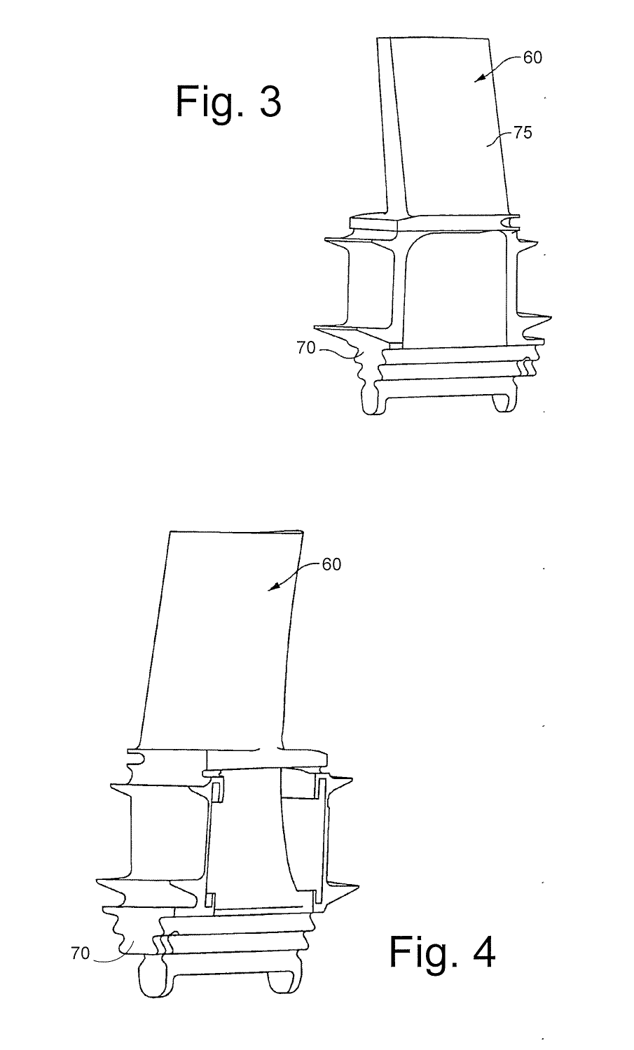

FIG. 2 is a perspective view of an example of a gas turbine disk segment 55 with a gas turbine blade 60. The disk segment 55 may include a dovetail slot 65 that receives a correspondingly shaped blade dovetail 70 to secure the turbine blade 60 to the disk 55. FIG. 3 and FIG. 4 show opposite sides of the turbine blade 60 including an airfoil 75 and the blade dovetail 70. FIG. 3 illustrates a pressure side of the turbine blade 60 and FIG. 4 illustrates a suction side of the turbine blade 12. The dovetail slots 65 typically are termed “axial entry” slots in that the dovetails 70 of the blades 60 may be inserted into the dovetail slots 65 in a generally axial direction, i.e., generally parallel but skewed to the axis of the disk 55.

The interface surfaces between the blade dovetail 70 and the disk dovetail slot 65 may be subject to stress concentrations. An example of a stress concentrating feature may be a cooling slot. As described above, the upstream or downstream face of the turbine blade 60 and the disk 55 may be provided with an annular cooling slot that extends circumferentially there around and passes through a radially inner portion of each dovetail 70 and dovetail slot 65. Cooling air (e.g., compressor discharge air and the like) may be supplied to the cooling slot which in turn supplies cooling air into the radially inner portions of the dovetail slots 65 for transmittal through grooves or slots (not shown) in the base portions of the blades 60 for cooling the interior of the blade airfoil portions 75.

A second example of a stress concentrating feature may be a blade retention or a lockwire tab 80. A forward end 85 or an aft end 90 of the blade 60 may be provided with the lockwire tab 80 defining an annular retention slot that extends circumferentially therearound, passing through the radially inner portion of each dovetail 70 and dovetail slot 65. A blade retention wire may be inserted into the lockwire tab 80 which in turn provides axial retention for the blades. In either of these examples and in similar situations, the stress concentrations potentially may be life-limiting locations of the turbine disk 55 and/or turbine blade 60.

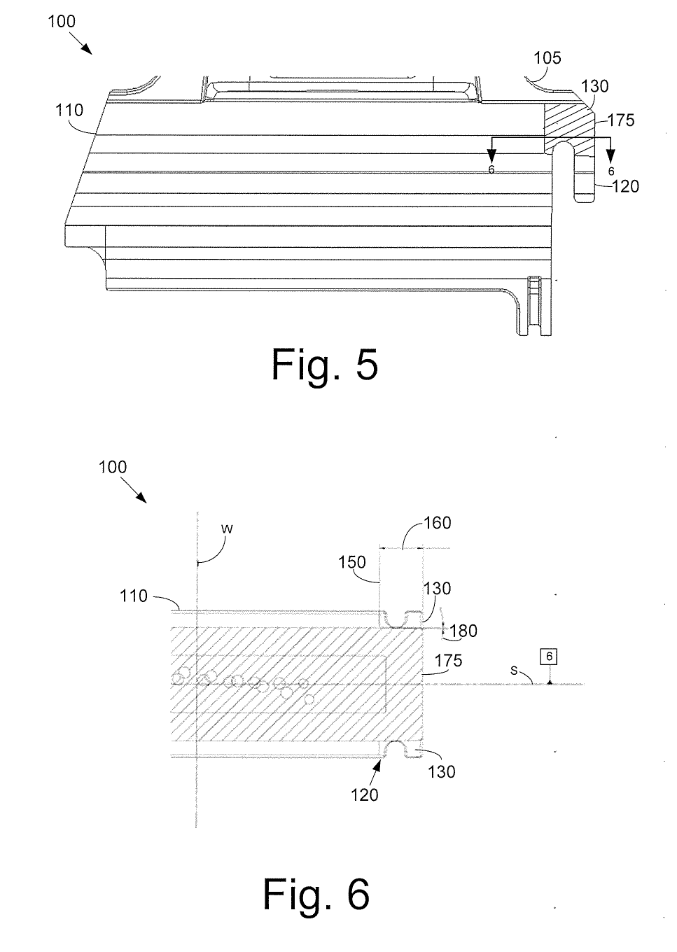

FIGS. 5 and 6 show an example of a turbine blade 100 as may be described herein. In this example, the turbine blade 100 may part of a second stage of a 9E.04 gas turbine engine offered by General Electric Company of Schenectady, N.Y. Other types of gas turbine engines may be used herein. The turbine blade 100 may include an airfoil 105 and a dovetail 110 similar to that described above. The turbine blade 100 may include a lockwire tab 120 positioned about the dovetail 110. Depending on the turbine class and blade and disk stage, the lockwire tab 120 may be on either the forward end 85 or the aft end 90 end of the dovetail 110. In this example, the lockwire tab 120 is positioned about the aft end 90. One or more backcuts 130 may be formed by removing a predetermined amount of material from the lockwire tab 120. The material may be removed using any suitable process such as a grinding or milling process or the like. Moreover, these processes may be the same as or similar to the corresponding processes used for forming the blade dovetail 110 (and/or disk dovetail slot 65).

The amount of material to be removed and thus the size of the backcut 130 may be determined by first finding a starting line 150 for the dovetail backcut 130, i.e., the starting line 150 defining a length 160 therefrom of the backcut 130 along the dovetail axis to a front end 170 or an aft end 175. A cut angle 180 also may be determined for the backcut 130. The starting line 150 and the cut angle 180 may be optimized according to blade and disk geometry so as to maximize a balance between stress reduction on the turbine disk 55, stress reduction of the turbine blade 100, a useful life of the turbine blade 100, and maintaining or improving the aeromechanical behavior of the turbine blade 100. As such, if a backcut 130 is too large, the backcut 130 may have a negative effect on the life span of the turbine blade 100. If the backcut 130 is too small, although the life of the turbine blade 100 may be maximized, stress concentrations in the interface between the turbine blade and the disk may not be minimized such that the disk may not benefit from the maximized life span. The backcut 130 may be planar or non-planar. In this context, the cut angle 180 may be defined as a starting cut angle. The backcuts 130 may be formed in one or both of the pressure side and suction side of the turbine blade 100.

The starting line 150 and the cut angle 180 for the backcut 130 may be determined by executing finite element analyses on the geometry of the blade and the disk. Virtual thermal and structural loads based on engine data may be applied to finite element grids of the blade 100 and the disk 55 to simulate engine operating conditions. The no-backcut geometry and a series of varying backcut geometries may be analyzed using the finite element model. A transfer function between the backcut geometry and blade and disk stresses may be inferred from the finite element analyses. The predicted stresses then may be correlated to field data using proprietary materials data in order to predict blade and disk lives and blade aeromechanical behavior for each backcut geometry. An optimum backcut geometry and an acceptable backcut geometry range may be determined through consideration of both the blade and disk life and the blade aeromechanical behavior.

The optimized starting line 150 and the cut angle 180 for each backcut 130 thus may be determined by using finite element analyses in order to maximize a balance between stress reduction on the turbine disk, stress reduction on the turbine blades, a useful life of the turbine blades, and maintaining or improving the aeromechanical behavior of the gas turbine blade. Although specific dimensions will be described, the turbine blade 100 described herein is not necessarily meant to be limited to such specific dimensions. The maximum dovetail backcut may be measured by the nominal distance between the starting line 150 and the front end 170 or the aft end 175. Through the finite element analyses, it has been determined that a larger dovetail backcut would result in sacrifices to the acceptable life of the gas turbine blade.

Alternatively, the starting line 150 also may be determined using finite element analysis based upon a predetermined the datum line W through the dovetail 110. The datum line W provides an identifiable reference point for each stage blade and disk of each turbine class for locating the optimized dovetail backcut starting line. In this example, the backcut 130 may be optimized for a second stage of a 9E.04 gas turbine engine offered by General Electric Company of Schenectady, N.Y.

The length 160 of the backcut 130 may be about 0.6 inches (about 15.24 millimeters), plus or minus 0.065 inches (about 1.65 millimeters), i.e., from the starting line 150 to the aft end 175. Different lengths 160, however, also may be used herein. The cut angle 180 also may be determined for the dovetail backcut 130. In this example, the cut angle 180 may be about 1.0 degrees, plus or minus about 0.3 degrees. Other cut angles 180 may be used herein. Other suitable sizes, shapes, and configurations may be used herein.

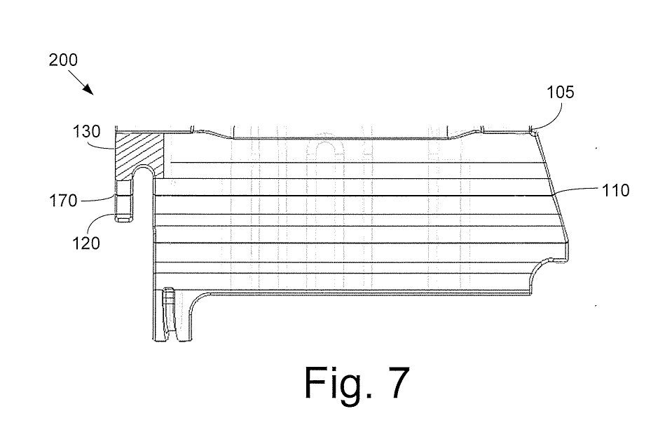

FIG. 7 shows a further embodiment of a turbine blade 200 as may be described herein. In this example, the turbine blade 200 may part of a first stage of a 9E.04 gas turbine engine offered by General Electric Company of Schenectady, N.Y. The turbine blade 100 may include an airfoil 105 and a dovetail 110 similar to that described above. The turbine blade 100 may include a lockwire tab 120 positioned about the dovetail 110. In this example, the lockwire tab 120 is positioned about the forward end 170. The lockwire tab 120 may have a backcut 130 therein. The backcut 130 may have similar dimensions to those described above.

It is anticipated that the backcuts may be formed into a unit during a normal hot gas path inspection process. With this arrangement, the blade load path should be diverted around the high stress region in the disk and/or blade stress concentrating features. The relief cut parameters including an optimized starting line and an optimized cut angle define a backcut that maximizes a balance between stress reduction in the gas turbine disk, stress reduction in the gas turbine blades, a useful life of the gas turbine blades, and maintaining or improving the aeromechanical behavior of the gas turbine blade. The reduced stress concentrations serve to reduce distress in the gas turbine disk, thereby realizing a significant overall disk fatigue life benefit.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A method for reducing stress on a turbine blade, wherein a plurality of turbine blades are attachable to a disk, and wherein each of the turbine blades includes a dovetail with lockwire tab, the method comprising:
(a) determining a starting line for a backcut relative to a lockwire tab end, the starting line defining a length of the backcut along a dovetail axis;
(b) determining a cut angle for the backcut; and
(c) removing material from the lockwire tab according to the starting line and the cut angle to form the backcut, wherein the starting line and the cut angle are optimized according to blade geometry to maximize a balance between stress reduction on the blade, a useful life of the turbine blade, and maintaining or improving the aeromechanical behavior of the turbine blade, wherein the starting line is positioned about 0.6 inches (about 15.24 millimeters), plus or minus 0.065 inches (about 1.65 millimeters) from the lockwire tab end along the dovetail axis.

2. A method according to claim 1, wherein step (b) is practiced such that the cut angle is about 1.0 degrees, plus or minus about 0.3 degrees.

3. A method according to claim 1, wherein optimizing of the starting line and the cut angle is practiced by executing finite element analyses on the blade geometry.

4. A method according to claim 1, wherein step (a) is practiced by determining the starting line for the backcut relative to an aft end.

5. A method according to claim 4, wherein step (a) is practiced by determining the starting line for the backcut relative to a stage two bucket.

6. A method according to claim 1, wherein step (a) is practiced by determining the starting line for the backcut relative to a forward end.

7. A method according to claim 6, wherein step (a) is practiced by determining the starting line for the backcut relative to a stage one bucket.

8. A method according to claim 1, wherein step (c) is practiced by removing material from a lockwire tab suction side and/or a lockwire tab pressure side.

9. A turbine blade comprising an airfoil and a blade dovetail, wherein the blade dovetail includes a lockwire tab and wherein the lockwire tab comprises a backcut sized and positioned according to blade geometry to maximize a balance between stress reduction on the blade, a useful life of the turbine blade, and maintaining or improving the aeromechanical behavior of the turbine blade, wherein a starting line of the backcut, which defines a length of the backcut along a dovetail axis, is about 0.6 inches (about 15.24 millimeters), plus or minus 0.065 inches (about 1.65 millimeters) from a lockwire tab end along the dovetail axis.

10. A turbine blade according to claim 9, wherein a cut angle is about 1.0 degrees, plus or minus about 0.3 degrees.

11. A turbine blade according to claim 9, wherein the dovetail backcut has a non-planar surface.

12. A turbine blade according to claim 9, wherein the lockwire tab is positioned about an aft end.

13. A turbine blade according to claim 12, wherein the turbine blade comprises a stage two bucket.

14. A turbine blade according to claim 9, wherein the lockwire tab is positioned about a forward end.

15. A turbine blade according to claim 14, wherein the turbine blade comprises a stage one bucket.
